(19) United States
(12) Patent Application Publication
(10) Pub. No.: US 2023/0400152 A1
(43) Pub. Date: Dec. 14, 2023

(54) GAS FILLING SYSTEM

(71) Applicant: TOYOTA JIDOSHA KABUSHIKI KAISHA, Toyota-shi (JP)

(72) Inventors: Naoki OGIWARA, Nagoya-shi (JP); Yoshihiro NAKATA, Nisshin-shi (JP); Tomonori KANEKO, Nagoya-shi (JP)

(21) Appl. No.: 18/295,876

(22) Filed: Apr. 5, 2023

(30) Foreign Application Priority Data
Jun. 10, 2022 (JP) 2022-094089

(51) Int. Cl. F17C 5/00

(52) U.S. Cl. CPC F17C 5/007; F17C 2250/0439; F17C 2250/0636; F17C 2250/043; F17C 2250/0694; F17C 2250/032; F17C 2250/034; F17C 2270/0168; F17C 2205/0335; F17C 2221/012; F17C 2265/065; F17C 2270/0184

(57) ABSTRACT

A gas filling system includes a receiver that receives a temperature in a high pressure container measured by a temperature sensor by communication, and a flow rate control device that controls a flow rate of gas for filling, a pressure sensor that measures a pressure of gas for filling, and a controller. The controller controls the flow rate control device such that the high pressure container is filled with the gas at a preset first pressure rise rate, until a filling rate of the high pressure container reaches a preset first target filling rate, and the high pressure container is filled with the gas at a preset second pressure rise rate lower than the first pressure rise rate, until the filling rate of the high pressure container reaches, from the first target filling rate, a preset second target filling rate higher than the first target filling rate.

### CROSS-REFERENCE TO RELATED APPLICATION

This application claims priority to Japanese Patent Application No. 2022-094089 filed on Jun. 10, 2022, incorporated herein by reference in its entirety.

### BACKGROUND

### 1. Technical Field

The present disclosure relates to a gas filling system.

### 2. Description of Related Art

Various techniques have been disclosed for filling a high pressure container such as a hydrogen tank mounted on a fuel cell electric vehicle with hydrogen gas. For example, Japanese Unexamined Patent Application Publication No. 2017-053459 (JP 2017-053459 A) discloses a technique for accurately measuring an initial pressure in a hydrogen tank. From the initial pressure, an outside air temperature, and a tank capacity, a pressure rise rate of the hydrogen gas to be used for filling the tank is set, and for example, in a passenger car equipped with a fuel cell, filling is completed in approximately three minutes.

### SUMMARY

For large vehicles such as large buses and trucks equipped with fuel cells, the capacity of the hydrogen tank to be mounted is relatively very large compared to passenger cars equipped with fuel cells. Therefore, when the large vehicle is to be filled with fuel in a relatively short period of time, for example, approximately ten minutes, the pressure rise rate of hydrogen gas is needed to be increased as compared to filling the passenger car. However, the increase in the pressure rise rate also leads to the increase in the pressure loss in a path from a hydrogen station to the hydrogen tank. Since hydrogen gas filling is performed using the pressure difference between the hydrogen station and the hydrogen tank, the increase in pressure loss may reduce a hydrogen gas filling rate. Specifically, in a configuration in which the filling rate of the hydrogen tank is calculated based on the hydrogen gas pressure measured on the hydrogen station side and the temperature in the hydrogen tank, the filling rate is calculated using the pressure before the pressure drops due to the pressure loss. For this reason, on the hydrogen station's side, a determination is made that the target filling rate has been reached and the hydrogen gas filling is stopped, whereas the hydrogen tank is not actually filled with hydrogen gas to the target filling rate, which may lead to a decrease in the filling rate. The aforementioned problem that the filling rate decreases when a tank having a relatively large capacity is to be filled with hydrogen gas in a relatively short period of time is not limited to the configuration in which the hydrogen tank is filled with hydrogen gas, but is common to configurations in which any type of high pressure container is filled with any type of gas.

The present disclosure can be implemented as the following aspects.

An aspect of the present disclosure relates to a gas filling system configured to connect to a high pressure container and fill the high pressure container with gas. The gas filling system includes a receiver, a flow rate control device, a pressure sensor, and a controller. The receiver is configured to receive a temperature in the high pressure container measured by a temperature sensor through communication. The flow rate control device is configured to control a flow rate of the gas for filling. The pressure sensor is configured to measure a pressure of the gas for filling. The controller is configured to calculate a filling rate of the gas in the high pressure container based on the temperature received by the receiver and the pressure measured by the pressure sensor, and control a pressure rise rate of the gas with which the high pressure container is filled by controlling the flow rate control device. The controller is configured to control the flow rate control device such that the high pressure container is filled with the gas at a preset first pressure rise rate, until the filling rate of the high pressure container reaches a preset first target filling rate, and the high pressure container is filled with the gas at a preset second pressure rise rate lower than the first pressure rise rate, until the filling rate of the high pressure container reaches, from the first target filling rate, a preset second target filling rate higher than the first target filling rate.

In the aspect of the present disclosure, the first target filling rate may be 80% or more and less than 95%, and the second target filling rate may be 95% or more and 100% or less.

In the aspect of the present disclosure, the gas filling system may further include an outside air temperature sensor configured to detect a temperature of outside air, the first pressure rise rate may be a pressure rise rate in a map stored in the controller, and the controller may be configured to search the map to set the first pressure rise rate, based on an initial pressure in the high pressure container measured by pre-shot filling, a capacity of the high pressure container transmitted from the receiver, and a detected value of the outside air temperature sensor.

In the aspect of the present disclosure, the second pressure rise rate may be a smallest pressure rise rate among pressure rise rates in the map.

In the aspect of the present disclosure, the receiver may be an infrared communication device.

According to the aspect of the present disclosure, gas filling is performed at the preset first pressure rise rate up to the preset first target filling rate, and gas filling is performed at the preset second pressure rise rate lower than the first pressure rise rate from the first target filling rate to the preset second target filling rate higher than the first target filling rate. Since the second pressure rise rate is lower than the first pressure rise rate, the pressure loss in the gas filling path is relatively small. After filling at the first pressure rise rate is performed, filling is performed at the second pressure rise rate at which the pressure loss is relatively small, and thus a decrease in filling rate due to pressure loss can be suppressed. In addition, filling is performed at the first pressure rise rate up to the first target filling rate, and thus gas filling can be completed in a relatively short period of time compared to when filling is performed just at the second pressure rise rate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a gas filling system as an embodiment of the present disclosure;

FIG. 2 is a flowchart showing a procedure of pressure rise rate control executed in the gas filling system;

FIG. 3 is a graph showing an example of a relationship between time and pressure when a hydrogen tank is filled with gas according to a comparative example; and

FIG. 4 is a graph showing an example of a relationship between time and pressure when a hydrogen tank is filled with hydrogen gas by the gas filling system according to the embodiment.

### DETAILED DESCRIPTION OF EMBODIMENTS

### A. First Embodiment

### A1. Device Configuration

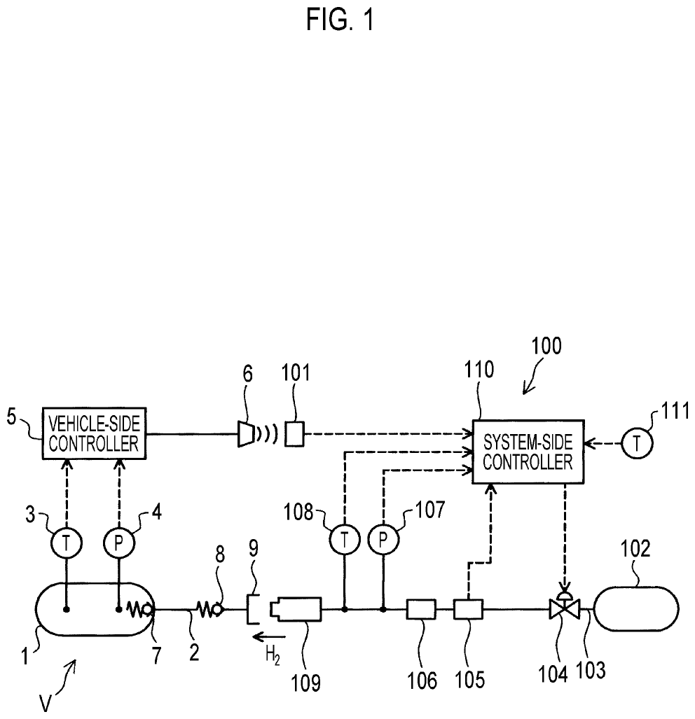

FIG. 1 is a block diagram showing a schematic configuration of a gas filling system 100 as an embodiment of the present disclosure. The gas filling system 100 is a system for filling a high pressure container with gas. The gas filling system 100 is used, for example, in a hydrogen station. Gas filling is performed by using the differential pressure between a pressure accumulator 102 storing the gas and the high pressure container. In the present embodiment, the gas is hydrogen gas, and the high pressure container is a hydrogen tank 1 mounted on a fuel cell electric vehicle V.

First, the configuration of the fuel cell electric vehicle V will be described. The fuel cell electric vehicle V is a vehicle that is equipped with a fuel cell system that generates electricity using hydrogen gas and air as fuel gas, and travels by driving a motor by using electrical power generated by the fuel cell system. In the present embodiment, the fuel cell electric vehicle V is, for example, a large vehicle such as a large bus or truck. The fuel cell electric vehicle V includes the hydrogen tank 1, a vehicle-side pipe 2, a vehicle-side temperature sensor 3, a vehicle-side pressure sensor 4, a vehicle-side controller 5, a transmitter 6, and a receptacle 9.

The hydrogen tank 1 is a tank that stores hydrogen supplied from the gas filling system 100. In the present embodiment, the hydrogen tank 1 is a tank having a larger capacity (for example, 80 kg) than the capacity of a hydrogen tank mounted on a passenger car.

The vehicle-side pipe 2 is a flow path for supplied hydrogen gas. A first end of the vehicle-side pipe 2 is connected to the hydrogen tank 1. A check valve 7 is provided at a connecting portion between the vehicle-side pipe 2 and the hydrogen tank 1 to prevent back flowing of the hydrogen gas in the hydrogen tank 1 toward the vehicle-side pipe 2. The receptacle 9 is provided at a second end of the vehicle-side pipe 2, and the receptacle 9 is configured to be connectable with a filling nozzle, which will be described later. A check valve 8 is provided at a connecting portion between the vehicle-side pipe 2 and the receptacle 9 to prevent back flowing of the hydrogen gas for filling toward the receptacle 9.

The vehicle-side temperature sensor 3 measures the temperature of the hydrogen gas in the hydrogen tank 1. The vehicle-side temperature sensor 3 is configured to be communicable with the vehicle-side controller 5. The measured temperature is transmitted to the vehicle-side controller 5 and used to calculate the filling rate in the hydrogen tank 1, which will be described later.

A vehicle-side pressure sensor 4 measures the pressure of hydrogen gas in the hydrogen tank 1. The vehicle-side pressure sensor 4 is configured to communicable with the vehicle-side controller 5. The measured pressure value is transmitted to the vehicle-side controller 5 and used in a program for determining whether the condition of hydrogen gas in the hydrogen tank 1 is normal, which will be described later. In addition, the measured pressure value is used as the value displayed by a fuel gauge indicating the remaining amount of hydrogen gas in the hydrogen tank 1.

The vehicle-side controller 5 is a computer including a processor and a memory. The memory of the vehicle-side controller 5 stores information about the hydrogen tank 1 including the capacity of the hydrogen tank 1 or a program for determining whether or not the condition in the hydrogen tank 1 is normal by using the measured values of the vehicle-side temperature sensor 3 and the vehicle-side pressure sensor 4 described above. According to the program, when at least one of the measured value of the vehicle-side temperature sensor 3 and the measured value of the vehicle-side pressure sensor 4 exceeds a preset threshold value, a determination is made that the condition inside the hydrogen tank 1 is not normal (abnormal). The vehicle-side controller 5 is configured to be communicable with the transmitter 6. The vehicle-side controller 5 transmits the measured value of the vehicle-side temperature sensor 3, the measured value of the vehicle-side pressure sensor 4, the internal conditions of the hydrogen tank 1, and the like to the gas filling system 100 via the transmitter 6.

The transmitter 6 is configured to be communicable with a receiver 101, which will be described later. The transmitter 6 is provided in the receptacle 9 of the fuel cell electric vehicle V.

Next, the gas filling system 100 will be described. The gas filling system 100 includes the pressure accumulator 102, a system-side pipe 103, a flow rate control device 104, a flow meter 105, a cooler 106, a system-side pressure sensor 107, a system-side temperature sensor 108, and an outside air temperature sensor. 111, a gas filling nozzle 109, a system-side controller 110, and the receiver 101.

The pressure accumulator 102 is a container that stores high pressure hydrogen gas to be supplied to the hydrogen tank 1. In the gas filling system 100, the number of the pressure accumulator 102 is not limited to one, and a plurality of the pressure accumulators 102 may be provided.

The system-side pipe 103 is a flow path for hydrogen gas supplied from the pressure accumulator 102. A first end of the system-side pipe 103 is connected to the pressure accumulator 102, and a second end of the system-side pipe 103 is connected to the gas filling nozzle 109, which will be described later.

The flow rate control device 104 controls the flow rate of hydrogen gas supplied from the pressure accumulator 102. The flow rate control device 104 is, for example, a pressure control valve. The flow rate of the supplied hydrogen gas is controlled by controlling the opening degree of the pressure control valve. The flow rate control device 104 is provided in the vicinity of the pressure accumulator 102 in the system-side pipe 103. Further, the flow rate control device 104 is connected to the system-side controller 110, which will be described later, and is controlled by the system-side controller 110.

The flow meter 105 is provided in the system-side pipe 103 downstream of the flow rate control device 104 and detects the amount of hydrogen gas flowing through the system-side pipe 103. Therefore, the amount of hydrogen gas measured by the flow meter 105 is the amount of hydrogen gas with the flow rate that is controlled by the flow rate control device 104. The flow meter 105 is connected to the system-side controller 110, which will be described later, and transmits the detected flow rate of hydrogen gas to the system-side controller 110.

The cooler 106 is provided in the system-side pipe 103 downstream of the flow meter 105 and cools the hydrogen gas flowing through the system-side pipe 103. When the hydrogen tank 1 is rapidly filled with hydrogen gas, the temperature of the hydrogen gas rises due to adiabatic compression. Therefore, to prevent too much rise in the temperature of the hydrogen gas in the hydrogen tank 1, the hydrogen gas is cooled in advance. The cooler 106 cools the hydrogen gas to −40° C., for example.

The system-side pressure sensor 107 is provided in the system-side pipe 103 downstream of the cooler 106 and detects the pressure of the hydrogen gas in the system-side pipe 103. Therefore, the pressure of hydrogen gas measured by the system-side pressure sensor 107 is the pressure of hydrogen gas that is controlled in flow rate by the flow rate control device 104 and that is cooled by the cooler 106. The system-side pressure sensor 107 is connected to a system-side controller 110, which will be described later, and transmits the detected hydrogen gas pressure to the system-side controller 110.

The system-side temperature sensor 108 is provided in the system-side pipe 103 downstream of the cooler 106 and detects the temperature of the hydrogen gas in the system-side pipe 103. Therefore, the temperature of hydrogen gas measured by the system-side temperature sensor 108 is the temperature of hydrogen gas that is controlled in flow rate by the flow rate control device 104 and that is cooled by the cooler 106. The system-side temperature sensor 108 is connected to the system-side controller 110, which will be described later, and transmits the detected hydrogen gas temperature to the system-side controller 110.

The outside air temperature sensor 111 detects the temperature of outside air. The detected outside air temperature is transmitted to the system-side controller 110 and used to set a pressure rise rate, which will be described later.

The gas filling nozzle 109 is configured to be connectable to receptacle 9 of the fuel cell electric vehicle V. By connecting the gas filling nozzle 109 and the receptacle 9, filling of the fuel cell electric vehicle V with hydrogen gas from the gas filling system 100 is started.

The receiver 101 is a device that receives information transmitted from the transmitter 6 of the fuel cell electric vehicle V. The receiver 101 is provided in the gas filling nozzle 109. The receiver 101 provided In the gas filling nozzle 109 and the transmitter 6 provided in the receptacle 9 face each other when the gas filling nozzle 109 is connected to the receptacle 9, which enables information to be transmitted and received. The transmission and reception of information are performed, for example, by infrared communication. Therefore, the transmitter 6 and receiver 101 are, for example, infrared communication devices. The receiver 101 can communicate with the system-side controller 110 to transmit information received from the transmitter 6 to the system-side controller 110.

The system-side controller 110 is a computer including a processor and a memory. The system-side controller 110 controls the operation of each section of the gas filling system 100. The memory of the system-side controller 110 stores a program for determining whether or not the condition of the supplied hydrogen gas is normal by using the measured values of the system-side pressure sensor 107 and the system-side temperature sensor 108. According to the program, when at least one of the measured value of the system-side pressure sensor 107 and the measured value of the system-side temperature sensor 108 exceeds a preset threshold value, a determination is made that the condition of the supplied hydrogen gas is not normal (abnormal). When the system-side controller 110 determines that the condition of the hydrogen gas is not normal (abnormal), the system-side controller 110 performs control such that the flow rate control device 104 closes to stop the hydrogen gas filling. In addition, when the vehicle-side controller 5 notifies that the condition of the hydrogen gas in the hydrogen tank 1 is not normal (abnormal), the system-side controller 110 performs control such that the flow rate control device 104 closes to stop the hydrogen gas filling.

Further, the system-side controller 110 sets the pressure rise rate of the hydrogen gas for filling by using the initial pressure in the hydrogen tank 1, the capacity of the hydrogen tank 1, and the measured value of the outside air temperature sensor 111. The pressure rise rate refers to the pressure rise value of the hydrogen gas for filling per unit time. Specifically, the pressure rise rate is set as follows. When the gas filling nozzle 109 and the receptacle 9 are connected, the capacity of the hydrogen tank 1 is transmitted from the transmitter 6 to the system-side controller 110 via the receiver 101. Next, the system-side controller 110 controls the flow rate control device 104 to perform pre-shot filling. Pre-shot filling is the hydrogen gas filling performed to acquire the initial pressure in the hydrogen tank 1 by increasing the pressure in the system-side pipe 103 and performing filling with a small amount of hydrogen gas in a short period of time at the start of hydrogen gas filling. The system-side controller 110 sets the pressure rise rate of the hydrogen gas for filling by using the initial pressure of the hydrogen tank 1, the capacity of the hydrogen tank 1, and the detected value of the outside air temperature sensor 111. The memory of the system-side controller 110 stores an ideal pressure rise rate map defined by the initial pressure in the hydrogen tank 1, the capacity of the hydrogen tank 1, and the measured value of the outside air temperature sensor 111, and from the parameters, the map is searched to set the pressure rise rate. Here, the ideal pressure rise rate refers to the pressure rise rate at which, when the hydrogen tank 1 is rapidly filled with hydrogen gas, the temperature inside the hydrogen tank 1 does not exceed a threshold temperature (for example, 85° C.), even though the temperature inside the hydrogen tank 1 rises due to adiabatic compression. The system-side controller 110 controls the opening degree of the flow rate control device 104 based on the set pressure rise rate.

The system-side controller 110 calculates the filling rate (state of charge; SOC) of the hydrogen gas with which the hydrogen tank 1 is filled. The filling rate refers to the ratio of a density of the gas put in for filling to a reference density of the gas. The reference density of the gas is, for example, 40.2 kg/m³ for hydrogen gas. The filling rate is calculated based on the measured value of the system-side pressure sensor 107 and the measured value of the vehicle-side temperature sensor 3. Specifically, the filling rate can be obtained using a gas state equation (1) as follows.

PV=nRT (1)

(here, P is the pressure of the gas, V is the volume of the gas, n is the number of moles of the gas, R is a gas constant, and T is the temperature of the gas.)

By substituting

n=w/M (2)

(here, w is the mass and M is the molecular weight.)

into the above equation (1), the equation can be expressed as

PV=wRT/M (3)

and dividing both sides by V, w/V is the density of the gas, so the equation can be expressed as

P=pRT/M (4)

(here, ρ is the density of the gas.)

In the above equation (4), P is the measured value of the system-side pressure sensor 107, T is the measured value of the vehicle-side temperature sensor 3, R is a constant, and M is a value defined by the type of gas for filling, and thus the density ρ can be obtained by substituting the numerical values. Then, using the obtained density ρ,

SOC(filling rate)=(ρ/ρ₀)×100 (5)

(here, ρ₀ is the reference density of the gas.)

The filling rate can be obtained by equation (5). The reason for using the measured value of the system-side pressure sensor 107 instead of the measured value of the vehicle-side pressure sensor 4 as the value of the pressure P is that the filling rate is calculated by using an inaccurate pressure value when the vehicle-side pressure sensor 4 is out of order and in this case, excessive filling of the hydrogen tank 1 with hydrogen gas over the capacity is to be suppressed.

### A2. Pressure Rise Rate Control

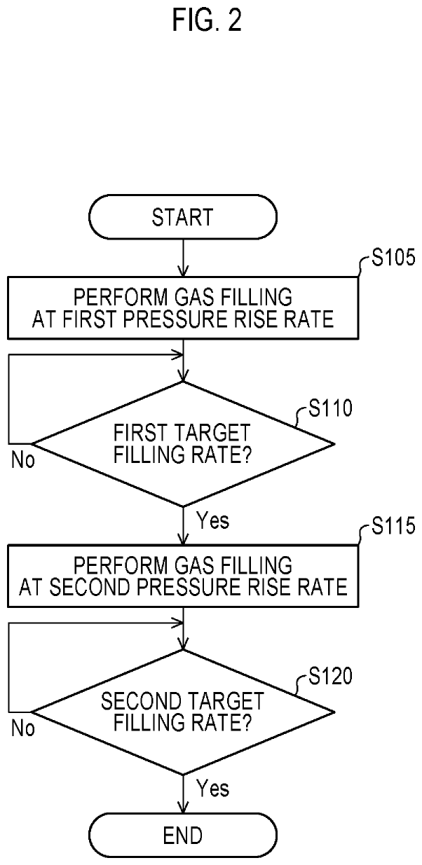

FIG. 2 is a flowchart showing a procedure of pressure rise rate control executed in the gas filling system 100. After the gas filling nozzle 109 is connected to the receptacle 9 and the initial pressure inside the hydrogen tank 1 due to pre-shot filling is measured, the system-side controller 110 executes pressure rise rate control.

The system-side controller 110 fills the hydrogen tank 1 with gas at a preset first pressure rise rate, until the filling rate of the hydrogen tank 1 reaches a preset first target filling rate (step S105).

The preset first target filling rate is any filling rate. The first target filling rate is, for example, any filling rate of 80% or more and 95% or less.

The preset first pressure rise rate is the pressure rise rate in the map stored in the memory of the system-side controller 110 described above. Therefore, the system-side controller 110 searches the map in memory to set the first pressure rise rate, by using the initial pressure in the hydrogen tank 1 measured by pre-shot filling, the capacity of the hydrogen tank 1 transmitted from the receiver 101, and the measured value of the outside air temperature sensor 111. The system-side controller 110 controls the opening degree of the flow rate control device 104 such that hydrogen gas filling is performed at the set first pressure rise rate.

The system-side controller 110 determines whether the filling rate of the hydrogen tank 1 reaches the first target filling rate (step S110). As described above, the filling rate is calculated based on the measured value of the system-side pressure sensor 107 and the measured value of the vehicle-side temperature sensor 3. The system-side controller 110 continues to fill the hydrogen tank 1 with hydrogen gas at the first pressure rise rate until a determination is made that the calculated filling rate is the first target filling rate.

When the determination is that the filling rate of the hydrogen tank 1 reaches the first target filling rate (Yes in step S110), the system-side controller 110 fills the hydrogen tank 1 with gas at a preset second pressure rise rate until the filling rate of the hydrogen tank 1 reaches a preset second target filling rate (step S115).

The preset second target filling rate is a filling rate higher than the first target filling rate. The second target filling rate is, for example, any filling rate of 95% or more and 100% or less.

The preset second pressure rise rate is a pressure rise rate lower than the first pressure rise rate. Such a pressure rise rate is, for example, the smallest pressure rise rate among the pressure rise rates defined in the map. The system-side controller 110 controls the opening degree of the flow rate control device 104 such that hydrogen gas filling is performed at the second pressure rise rate.

The system-side controller 110 determines whether the filling rate of the hydrogen tank 1 reaches the second target filling rate (step S120). The system-side controller 110 continues to fill the hydrogen tank 1 with gas at the second pressure rise rate until a determination is made that the filling rate of the hydrogen tank 1 reaches the second target filling rate. When the determination is made that the filling rate of the hydrogen tank 1 reaches the second target filling rate (Yes in step S120), the system-side controller 110 determines that the filling of the hydrogen tank 1 with hydrogen gas is completed and ends the hydrogen gas filling.

The reason will be described below that the system-side controller 110 controls the flow rate control device 104 such that the hydrogen tank 1 is filled with hydrogen gas at the preset first pressure rise rate, until the filling rate of the hydrogen tank 1 reaches the preset first target filling rate, and the hydrogen tank 1 is filled with hydrogen gas at the preset second pressure rise rate lower than the first pressure rise rate until the filling rate of the hydrogen tank 1 reaches the preset second target filling rate that is higher than the first target filling rate from the first target filling rate.

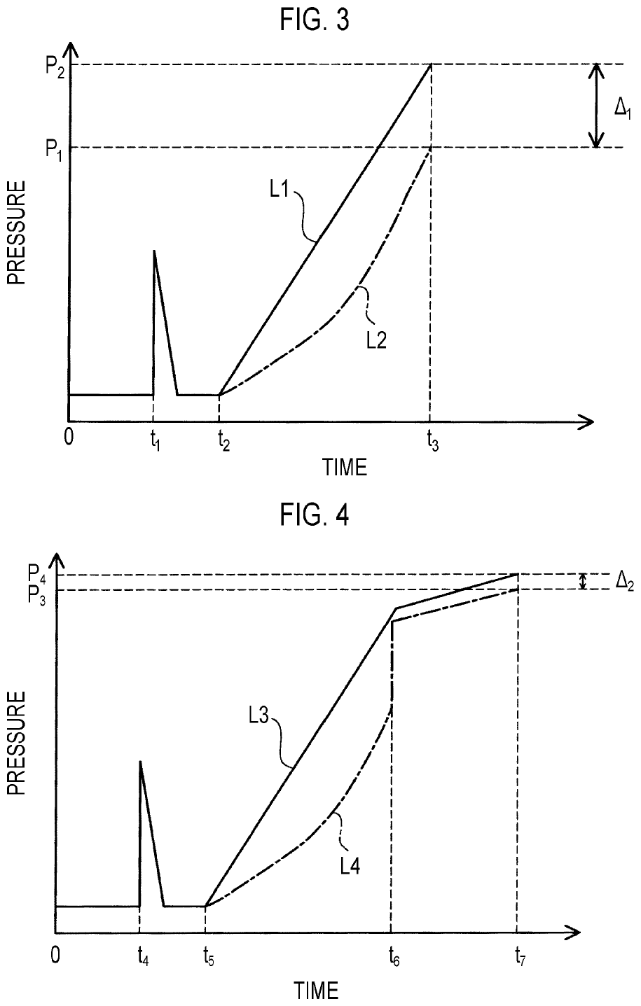

FIG. 3 is a graph showing an example of a relationship between time and pressure when the hydrogen tank 1 is filled with hydrogen gas according to a comparative example. The horizontal axis indicates an elapsed time when the connection time between the gas filling nozzle 109 and the receptacle 9 is set to 0, and the vertical axis indicates the pressure. A solid line L1 indicates the measured value of the system-side pressure sensor 107, and a dashed-dotted line L2 indicates the measured value of the vehicle-side pressure sensor 4. The hydrogen tank 1 filled with hydrogen gas is a relatively large-capacity hydrogen tank 1 mounted on a large bus, truck, or the like, and has a capacity of approximately 80 kg. In the comparative example, hydrogen gas filling is performed just at the first pressure rise rate (that is, the ideal pressure rise rate stored in the memory of the system-side controller 110).

After the gas filling nozzle 109 and the receptacle 9 are connected, the initial pressure in the hydrogen tank 1 is measured by performing pre-shot filling at time t₁. As indicated by the solid line L1, filling is performed with a small amount of high pressure hydrogen gas in the pre-shot filling, and as a result, the measured value of the system-side pressure sensor 107 is temporarily high, but the measured value of the vehicle-side pressure sensor 4 is not changed.

After the initial pressure in the hydrogen tank 1 is measured by pre-shot filling, the system-side controller 110 controls the flow rate control device 104 to start filling the hydrogen tank 1 with hydrogen gas at the first pressure rise rate from time t₂ up to the target filling rate. The target filling rate in the comparative example is set to 98%. As described in equations (1) to (5), the filling rate can be obtained from pressure and temperature. When the measured value of the system-side pressure sensor 107 reaches P₁, which is the pressure value corresponding to the target filling rate, at time t₃, the system-side controller 110 determines that filling up to the target filling rate has been completed and ends the hydrogen gas filling. However, as indicated by the dashed-dotted line L2, the pressure in the hydrogen tank 1 is P₂ which is lower than the value P₁ indicated by the system-side pressure sensor 107. The reason is due to pressure loss in the path from the pressure accumulator 102 to the hydrogen tank 1. The pressure loss causes a difference between the pressure value measured by the system-side pressure sensor 107 and the pressure value measured by the vehicle-side pressure sensor 4, and as a consequence, although the system-side controller 110 has determined that the hydrogen tank 1 has been filled up to the target filling rate, it is likely that the hydrogen tank 1 is not actually filled up to the target filling rate.

Next, a case where the hydrogen tank 1 is filled with hydrogen gas by the gas filling system 100 according to the embodiment will be described. FIG. 4 is a graph showing an example of a relationship between time and pressure when the hydrogen tank 1 is filled with hydrogen gas by the gas filling system 100 according to the embodiment. The horizontal axis indicates an elapsed time when the connection time between the gas filling nozzle 109 and the receptacle 9 is set to 0, and the vertical axis indicates the pressure. A solid line L3 indicates the measured value of the system-side pressure sensor 107, and a dashed-dotted line L4 indicates the measured value of the vehicle-side pressure sensor 4. As in the comparative example, the hydrogen tank 1 having a relatively large capacity (approximately 80 kg) is filled with hydrogen gas. In the comparative example, the hydrogen tank 1 has been filled with hydrogen gas just at the first pressure rise rate; the gas filling system 100 according to the embodiment is different from the comparative example in that the hydrogen tank 1 is filled with hydrogen gas at the first pressure rise rate from time t₅ to time t₆, and the hydrogen tank 1 is filled with hydrogen gas at the second pressure rise rate from time t₆ to time t₇.

As in the comparative example, pre-shot filling is performed at time t 4. After the measurement by pre-shot filling, the system-side controller 110 sets the first pressure rise rate, and starts filling the first hydrogen tank 1 at the first pressure rise rate at time t₅ until the filling rate of the hydrogen tank 1 reaches the first target filling rate. The first target filling rate is set to 93%.

From when the measured value of the system-side pressure sensor 107 reaches a pressure value P₃ corresponding to the first target filling rate at time t₆, the system-side controller 110 determines that the filling rate of the hydrogen tank 1 has reached the first target filling rate, and controls the flow rate control device 104 such that the hydrogen tank 1 is filled with hydrogen gas at a second pressure rise rate until the filling rate of the hydrogen tank 1 reaches the second target filling rate. The second target filling rate is set to 98%. As indicated by the dashed-dotted line L4, at time t₆, the measured value of the vehicle-side pressure sensor 4 sharply rises, and the difference from the measured value of the system-side pressure sensor 107 indicated by a solid line L3 becomes small. The reason is because as the pressure rise rate is set to the second pressure rise rate, which is lower than the first pressure rise rate, the flow rate of the hydrogen gas flowing from the pressure accumulator 102 to the hydrogen tank 1 decreases, resulting in the decrease in the pressure loss between the pressure accumulator 102 and the hydrogen tank 1.

When the measured value of the system-side pressure sensor 107 reaches a pressure value P₄ corresponding to the second target filling rate at time t₇, the system-side controller 110 determines that the filling rate of the hydrogen tank 1 reaches the second target filling rate, and ends hydrogen gas filling. In this case, a differential pressure Δ₂ between the measured pressure value P₄ of the system-side pressure sensor 107 and the measured pressure value P₅ of the vehicle-side pressure sensor 4 is smaller than a differential pressure Δ₁ between the measured pressure value P₁ of the system-side pressure sensor 107 and the measured pressure value P₂ of the vehicle-side pressure sensor 4 in the gas filling according to the comparative example. The reason is because the pressure loss from the pressure accumulator 102 to the hydrogen tank 1 is reduced by filling the hydrogen tank 1 with hydrogen gas up to the first target filling rate, and then filling the hydrogen tank 1 with hydrogen gas at the second pressure rise rate smaller than the first pressure rise rate up to the second target filling rate. By setting the two stages of pressure rise rate, performing hydrogen gas filling at the first pressure rise rate, and then performing hydrogen gas filling at a second pressure rise rate lower than the first pressure rise rate in this way, the pressure loss in the path from the pressure accumulator 102 to the hydrogen tank 1 can be reduced, and the decrease in filling rate of the filled gas can be suppressed. In addition, by performing filling up to the first target filling rate at the first pressure rise rate, and then performing hydrogen gas filling up to the second target filling rate at the second pressure rise rate, the filling can be completed in a short period of time as compared with the case of performing filling just at the second pressure rise rate.

With the gas filling system 100 described above, the system-side controller 110 controls the flow rate control device 104 such that the hydrogen tank 1 is filled with hydrogen gas at the preset first pressure rise rate, until the filling rate of the hydrogen tank 1 reaches the preset first target filling rate, and the hydrogen tank 1 is filled with hydrogen gas at the preset second pressure rise rate lower than the first pressure rise rate from the first target filling rate to the preset second target filling rate. In other words, gas filling is performed up to the first target filling rate at the first pressure rise rate, which is an ideal pressure rise rate, and then gas filling is performed up to the second target filling rate at the second pressure rise rate with small pressure loss. Therefore, even when the relatively large-capacity hydrogen tank 1 is filled with hydrogen gas, the gas filling can be completed in a relatively short period of time while a decrease in filling rate is suppressed.

### B. Another Embodiment

(B1) In the first embodiment, it has been described that the high pressure container is the hydrogen tank 1 mounted on the fuel cell electric vehicle V, and the gas is hydrogen gas; however, the present disclosure is not limited thereto. The high pressure container may be a relatively large hydrogen tank used in a fuel cell installed in a plant. The gas may be high pressure gas such as oxygen, nitrogen, argon, or helium. In the above case, the high pressure container may be a container storing high pressure gas such as oxygen, nitrogen, argon, or helium.

The present disclosure is not limited to the above-described embodiments, and can be carried out by various configurations without departing from the spirit of the present disclosure. For example, the technical features of the embodiments corresponding to the technical features in each mode described in the section of Summary can be appropriately replaced or combined to solve some or all of the above problems, or achieve some or all of the above-described effects. If the technical features are not described as essential in the present specification, the technical features can be deleted as appropriate.

What is claimed is:

1. A gas filling system configured to connect to a high pressure container and fill the high pressure container with gas, the gas filling system comprising:
a receiver configured to receive a temperature in the high pressure container measured by a temperature sensor through communication;
a flow rate control device configured to control a flow rate of the gas for filling;
a pressure sensor configured to measure a pressure of the gas for filling; and
a controller configured to calculate a filling rate of the gas in the high pressure container based on the temperature received by the receiver and the pressure measured by the pressure sensor, and control a pressure rise rate of the gas with which the high pressure container is filled by controlling the flow rate control device,
wherein the controller is configured to control the flow rate control device such that the high pressure container is filled with the gas at a preset first pressure rise rate, until the filling rate of the high pressure container reaches a preset first target filling rate, and the high pressure container is filled with the gas at a preset second pressure rise rate lower than the first pressure rise rate, until the filling rate of the high pressure container reaches, from the first target filling rate, a preset second target filling rate higher than the first target filling rate.

2. The gas filling system according to claim 1, wherein:
the first target filling rate is 80% or more and less than 95%; and
the second target filling rate is 95% or more and 100% or less.

3. The gas filling system according to claim 1, further comprising an outside air temperature sensor configured to detect a temperature of outside air, wherein:
the first pressure rise rate is a pressure rise rate in a map stored in the controller; and
the controller is configured to search the map to set the first pressure rise rate, based on an initial pressure in the high pressure container measured by pre-shot filling, a capacity of the high pressure container transmitted from the receiver, and a detected value of the outside air temperature sensor.

4. The gas filling system according to claim 3, wherein the second pressure rise rate is a smallest pressure rise rate among pressure rise rates in the map.

5. The gas filling system according to claim 1, wherein the receiver is an infrared communication device.
